(19) United States
(12) Patent Application Publication
(10) Pub. No.: US 2022/0259978 A1
(43) Pub. Date: Aug. 18, 2022

(54) ROTOR BLADE FOR A TURBOMACHINE, ASSOCIATED TURBINE MODULE, AND USE THEREOF

(71) Applicant: MTU Aero Engines AG, Muenchen (DE)

(72) Inventors: Karl MAAR, Muenchen (DE); Joerg FRISCHBIER, Muenchen (DE); Hans-Peter HACKENBERG, Muenchen (DE)

(21) Appl. No.: 17/628,989

(22) PCT Filed: Jul. 14, 2020
(86) PCT No.: PCT/DE2020/000156

§ 371 Date: Jan. 21, 2022

(30) Foreign Application Priority Data
Jul. 23, 2019 (DE) 10 2019 210 880.6

(51) Int. Cl. F01D 5/14; F04D 29/32

(52) U.S. Cl. CPC F01D 5/141; F01D 5/147; F04D 29/324; F05D 2300/611; F05D 2220/323; F05D 2250/314; F05D 2260/941; F05D 2300/174; F05D 2240/303; F05D 2240/301

(57) ABSTRACT

A rotor blade (20) for placement in a gas channel (3) of a turbomachine (1), including a rotor blade airfoil (23) which, in relation to a flow in the gas channel (3), includes a front edge (23a) and a rear edge (23b) downstream therefrom, as well as a suction side (41) and a pressure side (42). The rotor blade airfoil (23) is provided with an inclination toward the suction side (41) over at least one section (45.1) of its radial rotor blade airfoil height (45). The inclination is set in such a way that during operation a centrifugal force bending moment (46), which effectuates the centrifugal force on the rotor blade airfoil (23) due to the inclination, is greater than a gas force bending moment (47) that acts on the rotor blade airfoil (23) due to the circulation around the rotor blade airfoil (23) in the gas channel (3).

### TECHNICAL FIELD

The present invention relates to a rotor blade for a turbomachine.

### BACKGROUND

The turbomachine may be a jet engine, for example, such as a turbofan engine. The turbomachine is functionally divided into a compressor, a combustion chamber, and a turbine. In the case of the jet engine, for example, aspirated air is compressed by the compressor and combusted with admixed jet fuel in the downstream combustion chamber. The resulting hot gas, a mixture of combustion gas and air, flows through the downstream turbine and is expanded in the process. The turbine is generally made up of multiple stages, each including a stator (guide blade ring) and a rotor (rotor blade ring), and the rotors are driven by the hot gas. In each stage, internal energy is proportionately withdrawn from the hot gas and converted into a motion of the particular rotor blade ring, and thus of the shaft.

### SUMMARY OF THE INVENTION

The present subject matter relates to a rotor blade for placement in the gas channel of the turbomachine. The rotor blade may generally also be used in the compressor area, i.e., situated in the compressor gas channel; use in the turbine area, i.e., placement in the hot gas channel, is preferred.

It is an object of the present invention to provide a particularly advantageous rotor blade.

This is achieved according to the present invention by use of the rotor blade for placement in a gas channel of a turbomachine, including a rotor blade airfoil which, in relation to a flow in the gas channel, includes a front edge and a rear edge downstream therefrom, as well as a suction side and a pressure side. The rotor blade airfoil thereof is inclined, at least in sections, toward the suction side. This inclination is set in such a way that during operation a centrifugal force bending moment, which effectuates the centrifugal force on the rotor blade airfoil due to the inclination, is greater than a gas force bending moment that acts on the rotor blade airfoil due to the circulation around the rotor blade airfoil in the gas channel. A gas force bending moment is thus overcompensated for, in particular at least in sections. Simply stated, during operation the rotor blade is bent toward the sheet pressure side, driven by centrifugal force. For blade profiles with a curvature, on the suction side this increases the stresses in the area of the mid-chord regions (profile rear areas), whereas the stresses are decreased on the pressure side and at the leading edge and trailing edge. Thus, due to the targeted pretensioning of the rotor blade airfoil, during operation the relative stress on the pressure side may be reduced, and due to the curvature may also be reduced at the front edge, which increases the impact tolerance, i.e., the resistance to (foreign) particle impacts. Because of the relieving of stress at the front edge due to the fact that the rotor blade airfoil material is under less stress there during operation (the relative stress may be reduced by up to 20%, for example), only a fairly high-energy impact results in critical material damage.

In some specific embodiments, the inclination is set in such a way that during operation the centrifugal force bending moments on at least 50% of the rotor blade airfoil height and/or at least 50% to 80%, in particular at least 25% to 95%, of the rotor blade airfoil height, measured from radially inwardly to outwardly, which the centrifugal force exerts on the rotor blade airfoil due to the inclination at the particular radial positions, are in each case greater than the gas force bending moments that act on the rotor blade airfoil due to the flow around the rotor blade airfoil in the gas channel at the particular radial positions, and in particular in each case are at least 1.25 times the particular gas force bending moments. Possible upper limits may be, for example, 3, 2.5, or 2 times higher. Preferred specific embodiments are set forth in the dependent claims and in the overall disclosure, in the description of the features, a distinction not always being made in particular between device aspects and method aspects or use aspects; in any case, the disclosure is to be implicitly construed with regard to all claim categories. For example, if the advantages of the rotor blade in a certain application are described, this is to be construed as a disclosure of the correspondingly designed rotor blade as well as of a corresponding use.

In some specific embodiments, the inclination of the rotor blade airfoil with respect to the suction side is designed in such a way that the stress in the leading edges and/or trailing edges is reduced to over at least 50% of the rotor blade airfoil height and/or from at least 50% to 80%, and in particular from at least 25% to 95%, of the rotor blade airfoil height, measured from radially inwardly to outwardly, is reduced by at least 30%, preferably by at least 50%, in particular by at least 70%, compared to the centrifugal force average stress on the particular radial position of the rotor blade airfoil.

This involves a comparatively sharp reduction compared to a conventional stress compensation with a possibly low reduction in areas, as used, for example, for purposes of optimizing the creep life span. With some specific embodiments according to the present invention, this may be accompanied by local excessive increases in stress and optionally a reduced creep life span, for example at the blade rear areas (mid-chord regions), in particular at the rotor blade hub at that location. This is generally avoided, but under certain conditions may be tolerated and thus consciously accepted, for example for creep-resistant high-temperature materials. The robustness and impact tolerance may thus be significantly improved as the result of locally reducing the stress in a targeted manner at the leading edge by a centrifugal force bending moment that is significantly uncompensated for during operation, due to a corresponding inclination and profile design.

A reduction in stress at the leading edge has a particularly positive effect on the robustness and is particularly preferred. In some specific embodiments, the reduction in stress at the leading edge is greater, in particular by at least 10% or 20%, than at the trailing edge.

The rotor blade airfoil is tilted or deflected, at least in sections, with respect to a radial line, in particular toward the suction side. For example, it is inclined tangentially, i.e., in the circumferential direction, and/or axially, i.e., in the axial direction. Viewed axially, the rotor blade airfoil is tilted or deflected, at least in sections, with respect to a radial line, in particular toward the suction side. In general, the terms “axial,” “radial,” and “circumferential” as well as the associated directions refer to the rotational axis about which the rotor blade rotates during operation and which typically coincides with a longitudinal axis of the turbomachine. Due to the “inclination,” a thread axis or thread curve, which joins together the centroids of area of the profile sections (tangential sections) at different radial positions, may be inclined with respect to the centrifugal force axis or radial direction. The center of gravity of the rotor blade airfoil is thus not situated on the centrifugal force axis, which generates a restoring force, namely, the centrifugal force bending moment. The centrifugal force bending moment is set in such a way that the gas force or the gas force bending moment is overcompensated for.

The gas pressure or the gas force that acts on the rotor blade airfoil during operation results from the profiling of the rotor blade airfoil due to the flow around same in the gas channel. The gas that is flowing around, i.e., the hot gas in the case of the preferred turbine application, exerts a bending moment on the rotor blade airfoil toward the suction side. Since the rotor blade airfoil is inclined, at least in sections, toward the suction side, the rotation results in a centrifugal force vector in the direction of the pressure side, i.e., the centrifugal force bending moment opposing the gas force bending moment.

In one preferred embodiment, the inclination is set in such a way that the centrifugal force bending moment is at least 1.25 times, preferably 1.5 times, the gas force bending moment. Possible upper limits may be 3, 2.5, or 2 times higher.

According to one preferred specific embodiment, the rotor blade airfoil is inclined more strongly with respect to the suction side in a radially middle section than in a radially inner section. The radially middle section may be, for example, between 20% and 60% of the rotor blade airfoil height, considered from radially inwardly to outwardly, and the radially inner section may correspondingly be between 0% and 20% of the rotor blade airfoil height. The likelihood of an impact radially inwardly may be less, for which reason the rotor blade airfoil may be inclined less or not at all at that location.

In one preferred specific embodiment, the rotor blade airfoil is inclined more strongly in a radially middle section than in a radially outer section. The former may be situated, for example, between 20% and 60% of the rotor blade airfoil height (viewed at the front), and the radially outer section may be correspondingly situated between 60% and 100% of the rotor blade airfoil height. The rotor blade airfoil may also not be inclined at all radially outwardly. In summary, a pattern of the inclination may be preferred such that the inclination increases section by section from radially inwardly to radially outwardly, reaches a maximum in the radially middle section, and subsequently decreases once again radially outwardly.

In one alternative specific embodiment, the pattern of the inclination is such that the inclination increases in the radially inner section from radially inwardly to radially outwardly, reaches a maximum in the radially middle section, and subsequently constantly continues radially outwardly in the radially outer section or continues with a maximum deviation of 10% from the maximum.

In one preferred embodiment, the rotor blade airfoil includes a radially outwardly decreasing profile surface over at least one section of the rotor blade airfoil height, for example over at least 60%, 70%, 80%, or 90% of the rotor blade airfoil height, particularly preferably over the entire rotor blade airfoil height (100%). The profile surface is viewed in each case in a tangential section. Due to the decrease radially outwardly, the edge load, or stated simply, the mass that pulls outwardly, is reduced. This may, for example, result in an advantageous distribution of the average stress or of the resistance moment over the rotor blade airfoil height, which may further increase the rupture strength or impact resistance (in particular in the hub area). It is also often possible to set a radial stress pattern in the blade profile in a targeted manner.

In general, the radially outwardly decreasing profile surface could also be achieved solely via a decreasing profile thickness. In one preferred embodiment the chord length decreases radially outwardly, which taken alone or in combination with a decreasing profile thickness may result in the desired profile surface pattern. A pattern of chord length S is preferably such that the radially inward length of chord length Si is greater than the radially outward length of chord length Sₐ by at least 10%, 20%, or 30% (increasingly preferred in the order stated). Possible upper limits may be at most 50% or 40%.

A thickening of the profile in areas may generally be of interest, also independently of the above-described profile surface pattern. The profile may be thickened, for example, in the radially outer 20% of the rotor blade airfoil height, which with regard to the profile surface is preferably overcompensated for by the decreasing chord length. In addition, a thickening in particular in the area of the front edge is possible, for example between 0% and 5% or between 0% and 10% of the chord length taken from upstream to downstream. Due to such an intentional deviation from a thin profile shape, which actually is more optimal aerodynamically, increased impact rates, i.e., a locally higher likelihood of impact by particles, may be taken into account.

According to one preferred specific embodiment, the outer shroud of the rotor blade is designed with only a single sealing fin. This sealing fin, also referred to as a sealing tip, during operation may cooperate with a radially inwardly facing sealing structure that rests relative to the housing. The sealing fin may advance slightly into the sealing structure, for example a honeycomb structure, which may then result overall in a good seal in the axial or radial direction. With regard to the sealing effect, the limitation to a single sealing fin may mean a certain disadvantage; however, the accompanying weight reduction may be advantageous due to the reduced edge load (cf. the above comments). For illustration, the weight of the outer shroud is reduced, for example, to at most 7 g for each rotor blade, so that, for example, a static average stress of at most 150 MPa may result in all profile sections of the blade profile.

According to one preferred specific embodiment, the rotor blade airfoil is made of a high temperature-resistant material. This may in particular be titanium aluminide, for example TNM. “High temperature-resistant” may mean, for example, suitability for temperatures up to at least 700° C. or even 800° C., such a high temperature resistance generally being accompanied by a lower ductility. This results in a greater vulnerability to impact, which is counteracted by the measure(s) described above. Modifications of the microstructure are also possible in order to increase the ductility of the brittle material. In particular, an intermetallic titanium aluminide alloy may be used which contains titanium and aluminum as main components with the highest atomic percentages, and which includes intermetallic phases, in particular α-Ti₃Al and/or γ-TiAl. Ti and Al together may have a proportion of greater than 90 at %. The proportion of Al may be in a range of 42 at % to 48 at %.

According to one advantageous specific embodiment, an alloy composition is used that contains 45-48 at % Al, 5-7 at % Nb, 0.3-0.7 at % W, 0-0.3 at % Si, and the remainder Ti and unavoidable impurities.

According to another advantageous specific embodiment, an alloy composition is used that contains 42-45 at % Al, 3.7-4.2 at % Nb, 0.8-1.2 at % Mo, 0.05-0.15 at % B, and the remainder Ti and unavoidable impurities.

The rotor blade airfoil, preferably the rotor blade as a whole, may be manufactured by casting, forging, and/or generative manufacturing and end contour milling (in particular made of high temperature-resistant material). In addition to the rotor blade airfoil and the previously mentioned outer shroud, the rotor blade may include a rotor blade root, for example, that may be mounted in a rotor disk. The rotor blade may also be combined with further or multiple rotor blades to form an integral multiple segment, and may also be part of a blade integrated disk (“blisk”).

In one preferred specific embodiment, the rotor blade airfoil is provided with a coating at least at the front edge. The coating may locally cover the front edge and optionally the rear edge, although the rotor blade airfoil may also be completely coated (“armor plating”).

In one preferred embodiment, the coating is designed as a multilayer system, i.e., made up of at least two layers situated one on top of the other. The combination of a brittle layer and a ductile layer may be advantageous, the ductile material preferably being provided in the interior and the brittle material being arranged thereon. The brittle material may shatter in the event of an impact, which consumes a portion of the impact energy. With the ductile material on the bottom and preferably being applied directly to the rotor blade airfoil, crack growth into the blade material may be prevented (the crack nuclei are situated in the brittle material). In one preferred embodiment, the brittle material is a ceramic material and/or the ductile material is a metallic material.

In one preferred embodiment, the rotor blade is designed for a high-speed rotor, in particular a high-speed turbine, for example a low-pressure turbine. Values of An² of at least 2000 m²/s² are regarded as “high-speed,” at least 2500 m²/s², 3000 m²/s², 3500 m²/s², 4000 m²/s², 4500 m²/s², or 5000 m²/s² being increasingly preferred in the order stated (possible upper limits may be at most 9000 m²/s², 7000 m²/s², or 6000 m²/s², for example). For a conventional rotor blade that is not designed for high-speed operation, An² may be approximately 1800 m²/s², for example. In general, An² results from the annulus space, in particular at the exit, multiplied by the square of the rotational speed in the ADP range. The aerodynamic design point (ADP) results under cruise conditions at cruising altitude, and is characterized by ideal incident flow conditions and the best efficiency and thus the lowest fuel consumption. Alternatively, if the circumferential speed at the blade tip (radially outwardly) is referred to, for a conventional rotor blade the circumferential speed may reach up to a maximum of 220 m/s, for example, whereas for a high-speed rotor blade it may be greater than 300 m/s or even 400 m/s.

Moreover, the present invention relates to a turbine module for an aircraft engine, in particular a geared turbofan engine, that includes a rotor blade provided herein. The turbine module may be designed in particular for “high-speed” operation of the rotor blade (cf. the discussion in the preceding paragraph). Due to the coupling via the gear, during operation the turbine module may rotate more quickly than the fan of the aircraft engine (high-speed). The turbine module is preferably a low-pressure turbine module.

The turbine module may preferably be designed in such a way that during operation the outer shroud of the rotor blade is cooled using a cooling fluid that is not led through the rotor blade itself. The cooling fluid, for example compressor air, may, for example, be led through a guide blade upstream from the rotor blade, from radially inwardly to radially outwardly, and thus brought to the outer shroud of the rotor blade. The temperature reduction accompanying the outer shroud cooling may be advantageous, for example, in that a possible shroud creep or blade profile creep may be reduced. Conversely, this may increase the leeway for a modification of the microstructure of the rotor blade material, i.e., may allow a material having slightly increased ductility, despite the high temperature-resistant design. In general, a combination of the above-described measures may be advantageous in that in sum, they may increase a critical impact energy above the requirement profile that is relevant in practice.

Moreover, the present invention relates to the use of a rotor blade or a turbine module provided herein, the rotor blade rotating with an An² of at least 2000 m/s; reference is made to the above discussion.

### BRIEF DESCRIPTION OF THE DRAWINGS

The present invention is explained in greater detail below with reference to one exemplary embodiment, it being possible for the individual features within the scope of the other independent claims besides the main claim to also be in some other combination that is essential to the present invention, in particular a distinction also not being made between the different claim categories.

FIG. 1 schematically shows a turbofan engine in an axial view;

FIG. 2 schematically shows a rotor blade of the engine according to FIG. 1 in a side view; and

FIG. 3 shows the rotor blade according to FIG. 2 in an axial view.

### DETAILED DESCRIPTION OF THE INVENTION

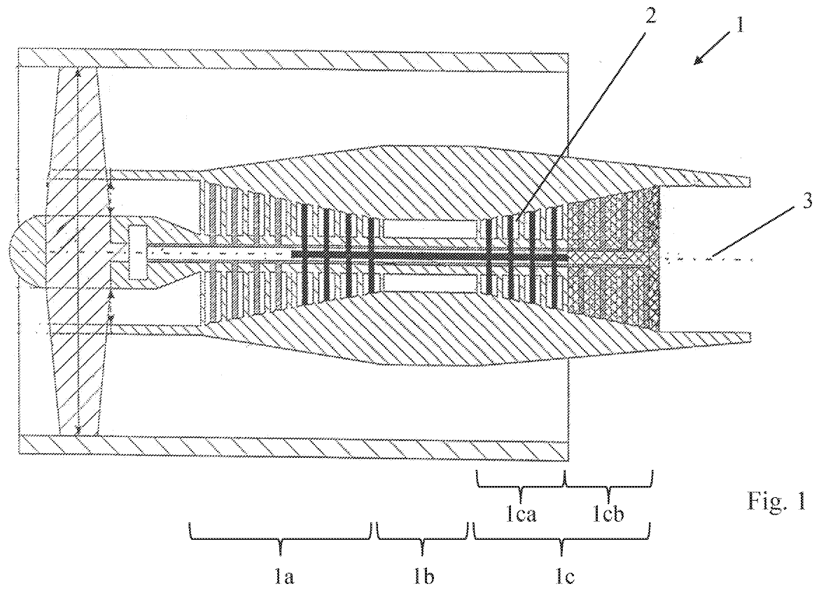

FIG. 1 shows a turbomachine 1, specifically, a turbofan engine, in a schematic view. Turbomachine 1 is functionally divided into a compressor 1a, a combustion chamber 1b, and a turbine 1c, the latter including a high-pressure turbine module 1ca and a downstream high-speed turbine module 1cb, in particular a low-pressure turbine module, that drives the fan and during operation rotates more quickly than the fan. Compressor 1a and turbine 1c are each made up of multiple stages, each stage being made up of a guide blade ring and a rotor blade ring. In relation to the circulation in gas channel 2, each stage of the rotor blade ring is situated downstream from the guide blade ring. The rotor blades rotate about longitudinal axis 3 during operation.

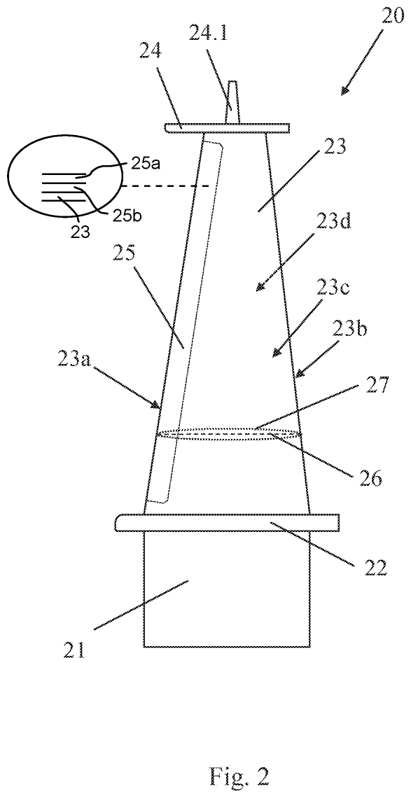

FIG. 2 shows a rotor blade 20 in a schematic side view, in particular a rotor blade 20 of a rotor blade ring of turbine 1c, specifically, of turbine module 1cb. In the present case, the rotor blade includes a blade root 21, not of further particular relevance here, and radially outside same includes an inner platform 22. Rotor blade airfoil 23 extends radially outwardly from inner platform 22. An outer shroud 24 that includes exactly one sealing fin 24.1 is situated at the radially outer end of rotor blade airfoil 23. This is advantageous with regard to the weight and thus the edge load (cf. in particular the introduction to the description).

In relation to the circulation in the hot gas channel, airfoil 23 includes a front edge 23a, a rear edge 23b, and two side surfaces 23c, 23d that respectively connect front edge 23a and rear edge 23b to one another. One of side surfaces 23c, d forms the suction side of rotor blade 20, and the other side surface forms the pressure side. At front edge 23a, for protection from impact damage, rotor blade 20 is provided with a coating 25 made up of a metallic layer 25b on the airfoil and a ceramic layer 25a situated on the metallic layer, shown solely schematically. It is also apparent from the illustration according to FIG. 2 that schematically shown chord length 26 and thus profile surface 27 decrease radially outwardly, which likewise reduces the edge load.

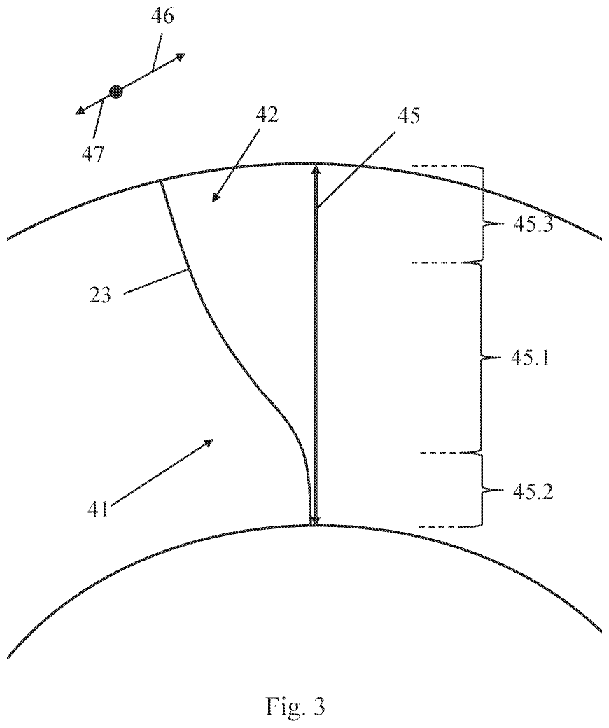

FIG. 3 schematically shows rotor blade airfoil 23 in an axial view illustrating the inclination of rotor blade airfoil 23. In the illustration, suction side 41 of rotor blade airfoil 23 is on the left side thereof, and pressure side 42 is on the right side thereof. Rotor blade airfoil 23 is inclined toward suction side 41, in particular in a radially middle section 45.1 of rotor blade airfoil height 45. The inclination is less in radially inner section 45.2 and radially outer section 45.3; rotor blade airfoil 23 may also extend into the hub or the housing entirely without inclination.

The inclination with respect to suction side 41 is set in such a way that during operation, centrifugal force bending moment 46 acting on rotor blade airfoil 23 is greater than gas force bending moment 47. As a result, rotor blade airfoil 23 is bent toward pressure side 42, which reduces the stress there, and thus the vulnerability to impact at front edge 23a (cf. the introduction to the description).

### LIST OF REFERENCE NUMERALS

turbomachine 1
compressor 1a
combustion chamber 1b
turbine 1c
turbine module 1ca
turbine module (high-speed) 1cb
gas channel 2
longitudinal axis 3
rotor blade 20
blade root 21
inner platform 22
airfoil 23
front edge 23a
rear edge 23b
side surfaces 23c, d
outer shroud 24
sealing fin 24.1
coating 25
chord length 26
profile surface 27
suction side 41
pressure side 42
rotor blade airfoil height 45
middle section 45.1
inner section 45.2
outer section 45.3
centrifugal force bending moment 46
gas force bending moment 47

1-15. (canceled)

16. A rotor blade for placement in a gas channel of a turbomachine, the rotor blade comprising:
an airfoil, the airfoil, in relation to a flow in the gas channel, including a front edge and a rear edge downstream from the front edge, as well as a suction side and a pressure side,
the airfoil being provided with an inclination toward the suction side over at least one section of a radial airfoil height,
the inclination being set in such a way that during operation a centrifugal force bending moment effectuating a centrifugal force on the airfoil is greater than a gas force bending moment acting on the airfoil due to the circulation around the airfoil in the gas channel.

17. The rotor blade as recited in claim 16 wherein the inclination of the airfoil with respect to the suction side is designed in such a way that stress in the leading edges or trailing edges is reduced over at least 50% of the airfoil height by at least 30% compared to the centrifugal force average stress on the particular airfoil height.

18. The rotor blade as recited in claim 16 wherein the inclination of the airfoil with respect to the suction side is designed in such a way that stress in the leading edges or trailing edges is reduced over at least 50% of the airfoil height by at least 50% compared to the centrifugal force average stress on the particular airfoil height.

19. The rotor blade as recited in claim 16 wherein the inclination of the airfoil with respect to the suction side is designed in such a way that stress in the leading edges or trailing edges is reduced over at least 50% of the airfoil height by at least 70% compared to the centrifugal force average stress on the particular airfoil height.

20. The rotor blade as recited in claim 16 wherein the inclination of the airfoil with respect to the suction side is designed in such a way that stress in the leading edges or trailing edges is reduced from at least 50% to 80% of the airfoil height by at least 30% compared to the centrifugal force average stress on the particular airfoil height.

21. The rotor blade as recited in claim 16 wherein the inclination of the airfoil with respect to the suction side is designed in such a way that stress in the leading edges or trailing edges is reduced from at least 50% to 80% of the airfoil height by at least 50% compared to the centrifugal force average stress on the particular airfoil height.

22. The rotor blade as recited in claim 16 wherein the inclination of the airfoil with respect to the suction side is designed in such a way that stress in the leading edges or trailing edges is reduced from at least 50% to 80% of the airfoil height by at least 70% compared to the centrifugal force average stress on the particular airfoil height.

23. The rotor blade as recited in claim 16 wherein the inclination of the airfoil with respect to the suction side is designed in such a way that stress in the leading edges or trailing edges is reduced from at least 25% to 95% of the airfoil height by at least 30% compared to the centrifugal force average stress on the particular airfoil height.

24. The rotor blade as recited in claim 16 wherein during operation the centrifugal force bending moment is at least 1.25 times the gas force bending moment.

25. The rotor blade as recited in claim 16 wherein the inclination of the airfoil with respect to the suction side in a radially middle section of the airfoil height is greater than in a radially inner section.

26. The rotor blade as recited in claim 16 wherein the inclination of the airfoil in a radially middle section of the airfoil height is greater than in a radially outer section, or the inclination of the airfoil in a radially outer section deviates from the maximum inclination in the radially middle section by a maximum of 10%.

27. The rotor blade as recited in claim 16 wherein the airfoil has a radially outwardly decreasing profile surface over at least one section of the airfoil height.

28. The rotor blade as recited in claim 16 wherein the airfoil has a radially outwardly decreasing chord length in the at least one section of the airfoil height (45).

29. The rotor blade as recited in claim 16 further comprising an outer shroud situated radially outwardly at the airfoil, a single sealing fin being situated radially outwardly at the outer shroud.

30. The rotor blade as recited in claim 16 wherein at least the airfoil is made of a high temperature-resistant material.

31. The rotor blade as recited in claim 16 further comprising a coating at least at the front edge.

32. The rotor blade as recited in claim 31 wherein the coating is a multilayer system that includes a ceramic layer and a metallic layer, the metallic layer being situated between the ceramic layer and the airfoil.

33. The rotor blade as recited in claim 16 wherein the rotor blade designed for a high-speed rotor having an An² of at least 2000 m/s².

34. A turbine module for an aircraft engine comprising the rotor blade as recited in claim 16.

35. A geared turbofan engine comprising the rotor blade as recited in claim 16.

36. The turbine module as recited in claim 34 designed as a low-pressure turbine module or a high-speed fan-driving turbine module, or designed to supply a cooling fluid to an outer shroud of the rotor blade, the cooling fluid being supplied from outside the rotor blade.

37. A method for operating the rotor blade as recited in claim 16 comprising rotating the rotor blade with an An² of at least 2000 m/s².

38. A method for operating a rotor blade placed in a gas channel of a turbomachine, the rotor blade having an airfoil, the airfoil, in relation to a flow in the gas channel, including a front edge and a rear edge downstream from the front edge, as well as a suction side and a pressure side, the airfoil being provided with an inclination toward the suction side over at least one section of a radial airfoil height, the method comprising:
rotating the rotor blade so that a centrifugal force and a gas force act on the rotor blade, the inclination being set in such a way that during operation a centrifugal force bending moment effectuating a centrifugal force on the airfoil is greater than a gas force bending moment acting on the airfoil due to the circulation around the airfoil in the gas channel.
